(19) United States
(12) Patent Application Publication
(10) Pub. No.: US 2026/0050067 A1
(43) Pub. Date: Feb. 19, 2026

(54) METHOD FOR OPERATING A LIDAR SENSOR SYSTEM

(71) Applicant: Robert Bosch GmbH, Stuttgart (DE)

(72) Inventors: Jens Werneth, Stuttgart (DE); Julian Hauss, Stuttgart (DE); Mario Lietz, Vaihingen An Der Enz (DE); Mirko Hattass, Stuttgart (DE)

(21) Appl. No.: 19/101,339

(22) PCT Filed: Sep. 18, 2023
(86) PCT No.: PCT/EP2023/075663

§ 371 Date: Feb. 5, 2025

(30) Foreign Application Priority Data
Sep. 23, 2022 (DE) 10 2022 210 072.7

(51) Int. Cl. G01S 7/481; G01S 7/497; G01S 17/88

(52) U.S. Cl. CPC G01S 7/4817; G01S 7/4815; G01S 7/497; G01S 17/88

(57) ABSTRACT

A method for operating a LiDAR sensor system. The LIDAR sensor system includes a transmitter unit, a receiver unit, and at least one mirror. The method includes: a) emitting transmitted radiation by means of the transmitter unit; b) in a first operating mode, aligning the at least one mirror such that the direction of the reflected radiation is influenced such that it is reflected in the direction of the receiver unit; and c) in a second operating mode, aligning the at least one mirror in such a way that the transmitted radiation of the transmitter unit is directed along a direct radiation path of the receiver unit.

### FIELD

The present invention relates to a method for operating a LiDAR sensor system comprising a transmitter unit and a receiver unit and at least two mirrors. Furthermore, the present invention relates to the use of the method in a LiDAR sensor system of a vehicle or a consumer electronic device.

### BACKGROUND INFORMATION

LiDAR sensors play an important role in the realization of driving functions in automated driving. LiDAR sensors transmit temporally structured light, which is reflected by objects and registered again by the sensor. The distance of objects can be determined based on measurements of the transit time of light. Due to the requirements of the safety standard ISO 262626, it is necessary to continuously monitor the functionality of the LiDAR sensor in order to avoid either immediate damage to the system or incorrect measured values that can cause an incorrect reaction from higher-level systems. Regardless of the use of sensors in the automotive sector, IEC 60825 (eye safety of laser systems) must also be observed. To ensure compliance, various monitoring mechanisms must be provided to recognize or prevent malfunctions at an early stage. Currently, the self-monitoring of laser light sources is made possible, for example, by internal reflections in the LiDAR housing, either to explicitly provided elements or by means of “undefined scattered light.”

PCT Patent Application No. WO 2019/197894 A1 relates to a LiDAR system and a method for internal light calibration. At least one processor of the LiDAR system controls at least one light source. A first group of input signals is obtained from a group of detectors that are related to the light that is projected from the first light source and reflected from an object outside the LiDAR system. A distance to the object is calculated based on the first number of input signals. A second number of input signals are received from the group of detectors that are related to the light that is projected internally to the LiDAR system with the at least one light source. Based on the second number of input signals, it is determined to what extent a performance degradation of the at least one detector in the group of detectors occurs. Based on this identified performance degradation, corrective action is initiated.

Germany Patent Application No. DE 10 2017 223 340 A1 relates to an object detection device. This comprises a light sensor and a light receiver, as well as a rotating scanner having a mirror and reflecting light from the light emitter from the mirror by rotating the mirror, in order to scan the reflected light over a predetermined region and to reflect light reflected from a target from the mirror and to guide the reflected light to the light receiver. Furthermore, an object detector is provided which detects whether there is a target based on a light reception signal. Furthermore, a light guide is provided, which directs light from the light emitter to the light receiver, as well as a failure detector that detects whether a failure exists based on a light emission state of the light emitter and a light reception state of the light receiver. The light guide receives light transmitted by the light transmitter and reflected by the mirror, and reflects the light from the mirror to guide the reflected light to the light receiver.

Germany Patent Application No. DE 10 2015 222 061 A1 relates to a LiDAR sensor for motor vehicles. The LiDAR sensor comprises a beam source that emits light in the visible or infrared range, a receiver for receiving the light reflected from the beam source on surfaces in the surrounding region of the vehicle and an electronic evaluation device for evaluating the transit times of the emitted and received light. The light source is configured to emit light at at least two different wavelengths. The evaluation device has a spectral evaluation channel for evaluating the intensity of the received light at different wavelengths.

### SUMMARY

According to the present invention, a method for operating a LiDAR sensor system is provided. According to an example embodiment of the present invention, the LiDAR sensor system comprises a transmitter unit and a receiver unit along with at least one mirror and at least the following method steps are carried out:
a) emitting transmitted radiation by means of the transmitter unit,
b) in a first operating mode (measuring mode), aligning the at least one mirror in such a way that the direction of the reflected radiation is influenced in such a way that it is reflected in the direction of the receiver unit; and
c) in a second operating mode (self-test mode), aligning the at least one mirror in such a way that the transmitted radiation of the transmitter unit is directed along a direct radiation path of the receiver unit.

In a particular example embodiment of the present invention, in the method for operating a LiDAR sensor system, at least the following method steps are carried out:
a) emitting transmitted radiation by means of the transmitter unit,
b) in a first operating mode (measuring mode), aligning the at least one mirror in such a way that a direction of reflected radiation is influenced and at least one further mirror receives the reflected radiation and reflects it in the direction of the receiver unit, and
c) in a second operating mode (self-test mode), aligning the at least one mirror in such a way that the transmitted radiation of the transmitter unit is directed along a direct radiation path via the at least one further mirror of the receiver unit.

In this variant of the present invention, at least one further mirror is required compared to the first variant.

The solution proposed according to the present invention makes it possible to advantageously achieve self-test mode of a LiDAR sensor system, which is extremely simple and allows the functionality of laser diodes of the radiation source to be monitored so that a degradation, failure or other malfunction can be recognized at an early stage. With the solution proposed according to the present invention, this can be achieved directly using the components already installed in the LiDAR sensor System without the installation of new elements or the use of scattered light.

In a further development of the method provided according to the present invention, different external angular ranges are measured by the LiDAR sensor system by rotating the at least one mirror, in particular a polygon mirror.

In an advantageous example embodiment of the method provided according to the present invention, depending on the rotation of the polygon mirror, a transition is carried out from a “measuring mode” operating mode to a “self-test mode” operating mode and vice versa. As a result, there is the option of switching from “measuring mode” to “self-test mode” at any time, thus achieving independence from fixed intervals.

In a further advantageous example embodiment of the method provided according to the present invention, light/radiation is substantially transmitted to the receiver unit via reflection as reflected radiation from objects in the “measuring mode” operating mode.

In a further development of the method provided according to an the present invention, light/radiation, in particular on the direct light path or radiation path, is directed to the receiver unit as transmitted radiation in the “self-test mode” operating mode. In this case, a check of the expected functionalities can be carried out without having to install additional separate components inside the LiDAR sensor system.

In the method provided according to an example embodiment of the present invention, an acceptance range is set according to the rotational position of the polygon mirror in relation to the transmitter unit, in such a way that no transmitted radiation passes directly from the transmitter unit to the receiver unit.

In an advantageous further development of the method provided according to the present invention, the radiation emitted by the transmitter unit substantially runs in the form of a vertical line. Furthermore, in the method proposed according to the present invention, the receiver unit is substantially designed to receive radiation in the form of vertical lines.

In an advantageous further development of the method provided according to the present invention, the receiver unit used is provided such that it either comprises a detector or a corresponding detector is assigned to the receiver unit, wherein the detector is advantageously designed as a line detector.

Furthermore, the present invention relates to the use of the method in a LiDAR sensor system of a vehicle or a consumer electronic device.

Due to the solution provided according to the present invention, a very simple monitoring of the functionalities, for example of the laser diodes of the transmitter unit, can be carried out, so that a degradation, imminent failure or any other malfunction that may become apparent at an early stage can be recognized on a timely basis. Within the framework of the “self-test mode” operating mode proposed according to the present invention, this diagnosis can be carried out in the LiDAR sensor system without the need for separate test elements or devices or even scattered light. The solution proposed according to the present invention can provide a direct light path that runs from the transmitter unit (the laser or the group of laser diodes) to a detector, i.e., the receiver unit, so that the receiver unit can be used both for the actual measurement of the objects to be detected and at the same time can be used for monitoring the LiDAR sensor system for imminent damage within the framework of self-test mode.

The solution provided according to the present invention makes it possible to avoid self-monitoring of laser sources, for example due to internal reflections inside the LiDAR housing, as shown for example in PCT Patent Application No. WO 19/197894 A1 or Germany Patent Application No. DE 10 2017 223 340 A1.

In the method provided according to the present invention, a rotational adjustment of a polygon mirror can advantageously be carried out in “self-test mode” operating mode in such a way that it either releases or interrupts the direct light path from the laser source in the direction of the detector. In the case of releasing the light path by the laser diodes or the transmitter unit comprising a plurality of grouped laser diodes, a check of time signals can be carried out within the framework of the self-test mode. If, for example, the transmitter unit is made up of different laser diodes or groups of laser diodes, different groups of laser diodes can be pulsed so that a check can be carried out to determine whether the expected functionality is present, to what extent it is present, and whether there is already previous damage that could lead to failure.

Advantageously, the method according to the present invention is provided such that it functions without any further reflective elements inside the LiDAR sensor housing, since a direct light path is used. With the conventional arrangements, on the other hand, the mode of operation is dependent, for example, on an age-related decrease in the reflectivity of a pane of the housing and, in particular, only certain materials can be considered for their selection, which require correspondingly higher costs.

### BRIEF DESCRIPTION OF THE DRAWINGS

Example embodiments of the present invention are explained in greater detail with reference to the figures and the following description.

FIG. 1 shows a LiDAR sensor system with a self-monitoring function according to the related art.

FIG. 2 shows a LiDAR sensor system that comprises a movable polygon mirror for carrying out a first example variant of the method proposed according to the present invention.

FIG. 3 shows the LiDAR sensor system according to a first variant of FIG. 2 in a “self-test mode” operating mode,

FIG. 4 shows an example embodiment variant of a LIDAR sensor System, wherein a measuring mode is carried out.

FIG. 5 shows an embodiment variant of a LiDAR sensor system with which the method provided according to the present invention for carrying out the “self-test mode” operating mode is implemented.

FIG. 6 shows a LiDAR sensor system that comprises a movable polygon mirror for carrying out a second variant of the method provided according to the present invention.

FIG. 7 shows the LiDAR sensor system according to a second first variant of FIG. 2 in a “self-test mode” operating mode.

### DETAILED DESCRIPTION OF EXAMPLE EMBODIMENTS

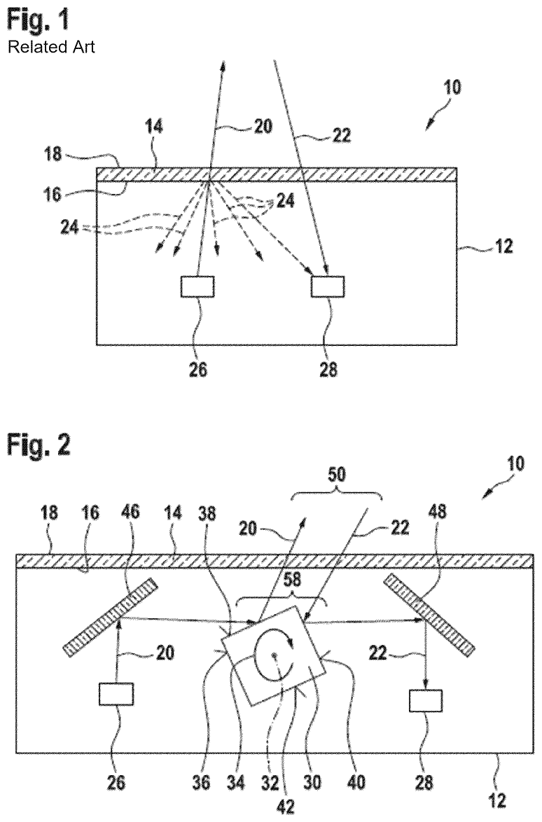

The representation according to FIG. 1 shows a LiDAR sensor system 10, the components of which are substantially arranged inside a housing 12. The housing 12 comprises a transparent cover 14, which can be in the form of a glass pane or glass ceiling, for example. The inner side thereof is denoted by reference sign 16, while an outer side of the transparent cover 14 is denoted by position 18. Inside the housing 12 of the LiDAR sensor system 10 shown in FIG. 1, there is a transmitter unit 26 that emits transmitted radiation 20, at least a part of which is reflected as scattered light 24 on the inner side 16 of the transparent cover 14. At least a part of this scattered light 24 reaches a receiver unit 28, which is also arranged inside the housing 12. According to the embodiment variant shown in FIG. 1, which reflects the related art, the LiDAR sensor system 10 shown there carries out a self-test based on the evaluation of the scattered light 24 inside the receiver unit 28.

In the following description of the example embodiments of the present invention, identical or similar elements are denoted by the same reference signs, and a repeated description of these elements in individual cases is dispensed with. The drawings show the subject matter of the present invention only schematically.

The representation according to FIG. 2 shows a LiDAR sensor system 10, in the housing 12 of which a transmitter unit 26 comprising a plurality of laser diodes or a plurality of groups of laser diodes is arranged. Furthermore, inside the housing 12 of the LiDAR sensor system 10, there is a receiver unit 28 that Serves as a detector or comprises one. The housing 12 is closed by the transparent cover 14, the inner side of which is denoted by the reference sign 16 and the outer side of which has the reference sign 18. Inside the housing 12, in addition to a first, substantially stationary deflecting mirror 46, there is a second deflecting mirror 48 opposite it. Between these two deflecting mirrors 46, 48, a further mirror, in particular a polygon mirror 30, is arranged, which can rotate about an axis of rotation 32, for example in the direction of rotation 34. In the above connection, the polygon mirror 30 comprises at least two facets or at least two mirror surfaces. It can be seen from the representation according to FIG. 2 that in this embodiment variant the polygon mirror 30 has a substantially square cross-section, comprising a first mirror surface 36, a second mirror surface 38, a third mirror surface 40 and a fourth mirror surface 42. The mirror surfaces 36, 38, 40, 42 are in each case oriented at 90° in relation to one another.

It can also be seen from the representation according to in FIG. 2 that in the “measuring mode” 50 operating mode shown there, radiation 20 transmitted by the transmitter unit 26 is deflected by 90° by the first deflecting mirror 46 and strikes a second mirror surface 38 of the polygon mirror 30 parallel to the transparent cover 14. From there, the transmitted radiation 20 reaches the outside. Radiation 22 reflected from a detected object, i.e., reflected light, re-enters the housing 12 of the LiDAR sensor system 10 via the transparent cover 14, is deflected at the third mirror surface 40 and strikes the upper side of the second deflecting mirror 48 arranged inside the housing 12 and from there onto the receiver unit 28, which serves as a detector. In the “measuring mode” 50 operating mode shown in FIG. 2, a light path between the first deflecting mirror 46 arranged so as to be stationary inside the housing 12 and the second deflecting mirror 48 arranged so as to be substantially stationary opposite it is interrupted by the rotational position of the polygon mirror 30, which can be rotated about its axis of rotation 32, as shown here, so that the emitted light, i.e., the transmitted radiation 20, only emerges from the housing 12 of the LiDAR sensor system 10.

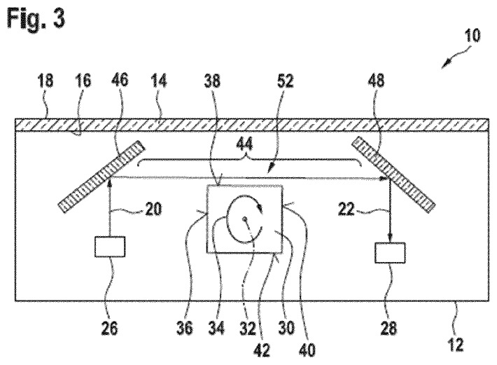

The representation according to FIG. 3 shows that, compared to the “measuring mode” 50 shown in FIG. 2, in the “self-test mode” 52 shown in FIG. 3 the polygon mirror 30, which is arranged between the two deflecting mirrors 46, 48, is swiveled into a rotational position in which a direct light path 44 between the first deflecting mirror 46 and the second deflecting mirror 48 is released inside the housing 12.

It can be seen from the representation according to FIG. 3 that in the “self-test mode” 52 operating mode of the LiDAR sensor system 10, the radiation 20 transmitted by the transmitter unit 26 is also deflected by 90° at the first deflecting mirror 46 and, due to the rotational position of the polygon mirror 30, strikes the upper side of the second deflecting mirror 48 inside the housing 12 directly parallel to the transparent cover 14. From there, the transmitted radiation 20, now deflected, strikes the receiver unit 28, which serves as a detector, where it can be evaluated.

The check of time signals can be carried out in the “self-test mode” 52 operating mode shown in FIG. 3. In the “self-test mode” 52 operating mode, for example, if the transmitter unit 26 is composed of different laser diodes or groups of laser diodes, it can be tested and checked by pulsing different groups of laser diodes whether the expected functionality is present or whether preliminary damage that could result in an imminent failure of the LiDAR sensor system 10 has possibly occurred in the laser diodes. Due to the option proposed according to the present invention of implementing a self-test mode in the LiDAR sensor system 10, it is no longer necessary to maintain corresponding test elements or to use scattered light according to the related art for testing the functionality. The solution proposed according to the present invention makes possible very simple monitoring of the functionality of laser diodes of the transmitter unit 26 in the “self-test mode” 52 operating mode of the LiDAR sensor system 10, so that a degradation, failure or any other malfunction that may occur can be recognized at an early stage.

It can be seen from the representation according to FIG. 3 that the provision of the direct light path 44 from the transmitter unit 26 via the first deflecting mirror 46 and the second deflecting mirror 48 and from there to the receiver unit 28 serving as a detector makes possible a double use of components present in the housing 12. For the actual measurement of objects, the “measuring mode” 50 shown in FIG. 2 can be selected and, if the polygon mirror 30 is rotated accordingly about its axis of rotation 32, for example in the direction of rotation 34, in this case clockwise, it is possible to switch to the “self-test mode”52 operating mode shown in FIG. 3.

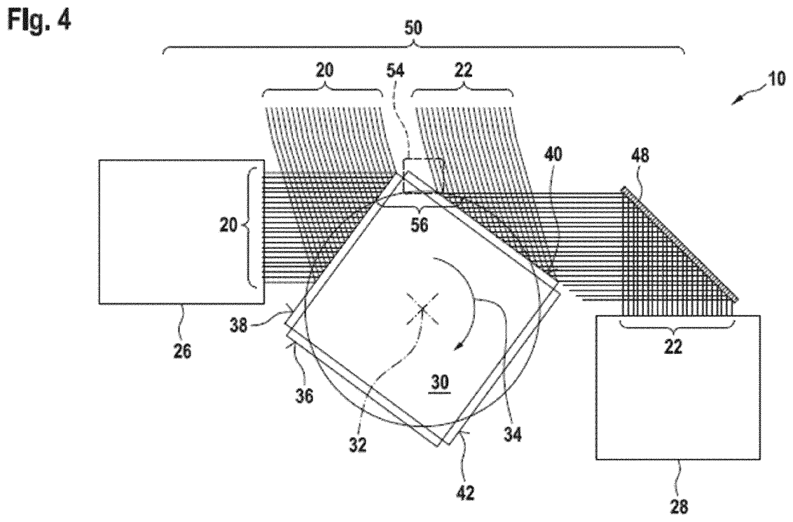

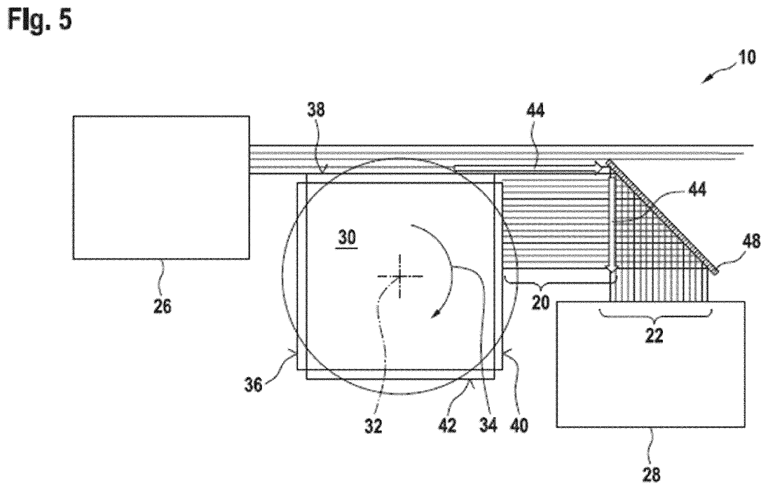

FIGS. 4 and 5 describe a possible embodiment variant of the LiDAR Sensor system 10 proposed according to the present invention.

It can be seen from the representation according to FIG. 4 that, in contrast to the LiDAR sensor system 10 described with reference to FIGS. 2 and 3, a first deflecting mirror 46 is missing in the embodiment variant according to FIG. 4. The transmitter unit 26 is displaced in comparison to the embodiment variant of the LiDAR sensor system 10 according to FIGS. 2 and 3, so that the transmitted radiation 20 strikes the second mirror surface 38 of the polygon mirror 30, which can be rotated about its axis of rotation 32, directly and from there leaves the housing, which is not shown in the representation according to FIG. 4, as transmitted radiation 20. In this embodiment variant, as shown in FIG. 4, radiation 22 reflected from a detected object strikes the third mirror surface 40, is deflected at the latter in the direction of the second deflecting mirror 48 and strikes the receiver unit 28 serving as a detector as reflected radiation 22.

As can be seen from the representation according to FIG. 4, the polygon mirror 30 can also be rotated about its axis of rotation 32, for example in the direction of rotation 34, in this embodiment variant. Here as well, the polygon mirror 30 has a substantially square cross-section, so that the first mirror surface 36, the second mirror surface 38, the third mirror surface 40 and the fourth mirror surface 42 are formed on its outer side, which in each case are oriented at 90° to the other.

Due to the selection of the acceptance range 54 in relation to the transmitter unit 26, no light can pass directly from the transmitter unit 26 to the receiver unit 28, which serves as a detector, when the polygon mirror 30 is tilted. Nevertheless, as can be seen from FIG. 4, the transmitted radiation 20 can leave the housing of the LiDAR sensor system 10 and radiation 22 reflected by objects can re-enter the LiDAR sensor system 10.

The representation according to FIG. 5 shows that in this embodiment variant, analogously to the embodiment variant of the LiDAR sensor system 10 according to FIG. 3, the polygon mirror 30 is rotated about its axis of rotation 32 in the direction of rotation 34, in this case clockwise, so that the second mirror surface 38 is oriented parallel to the transmitted radiation 20. As a result, a direct light path 44 from the transmitter unit 26 to the second deflecting mirror 48 arises, from where the transmitted radiation 20 strikes the receiver unit 28, which serves as a detector. Consequently, when the polygon mirror 30 is rotated accordingly about its axis of rotation 32,14, either in the direction of rotation 34, as shown in FIG. 5, or in the opposite direction of rotation, the direct light path 44 between the transmitter unit 26, on the one hand, and the receiver unit 28 serving as a detector, on the other hand, can be released.

Analogously to the representation according to FIG. 3, the position of the polygon mirror 30 about its axis of rotation 32 in the embodiment variant according to FIG. 5 also makes possible the “self-test mode” 52 operating mode, within the framework of which, for example, a check of timing signals can be undertaken or the light source, i.e., the transmitter unit 26, which comprises, for example, various laser diodes or groups of laser diodes, can be pulsed with different pulses, so that expected functionalities can be checked and degradations along with malfunctions can be recognized at an early stage.

The two embodiment variants of the LiDAR sensor system 10 shown in FIGS. 2 and 3 and FIGS. 4 and 5 have in common that they comprise the rotatable polygon mirror 30, which either makes possible the “measuring mode” 50 operating mode, as shown in FIGS. 2 and 4, by interrupting a direct light path 44 between the transmitter unit 26 and the receiver unit 28 with one of the mirror surfaces 36, 38, 40, 42, or, as shown in FIGS. 3 and 4, releasing the direct light path 44 between the transmitter unit 26 and the receiver unit 28, which serves as a detector, so that the “self-test mode” 52 operating mode can be realized. In an advantageous way, the “measuring mode” 50 operating mode or the “self-test mode” 52 operating mode can be carried out on the LiDAR sensor system 10 without having to provide separate test components in the LiDAR sensor system 10.

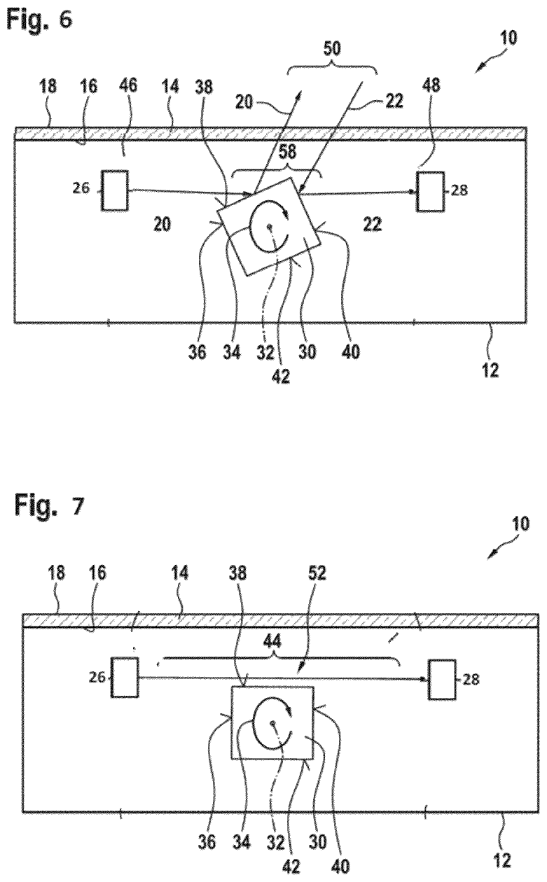

FIGS. 6 and 7 show a particularly advantageous variant of the present invention. The elements of these figures correspond to those of FIGS. 2 and 3, with the difference that the deflecting mirrors 46 and 48 can be dispensed with here due to the changed position of the receiver unit 28 and transmitter unit 26 compared to FIGS. 2 and 3. This is particularly advantageous, since it makes possible a highly compact design of the lidar. Depending on the position of the mirror 30, the outgoing radiation is measured directly by the receiver unit 28 (self-test mode, FIG. 7) or the mirror 30 is set in measuring mode (FIG. 6), so that the receiver unit 28 detects the radiation reflected by the objects to be detected.

The present invention is not limited to the exemplary embodiments described here and the aspects emphasized therein. Rather, a large number of modifications are possible within the scope of the present invention, which are within the scope of the activities of a person skilled in the art.

1-12. (canceled)

13. A method for operating a LiDAR sensor system including a transmitter unit, a receiver unit, and at least one mirror, the method comprising the following steps:
a) emitting transmitted radiation using the transmitter unit;
b) in a first operating mode, aligning the at least one mirror in such a way that a direction of reflected radiation is influenced in such a way that the received reflected radiation is reflected in a direction of the receiver unit; and
c) in a second operating mode, aligning the at least one mirror in such a way that the transmitted radiation of the transmitter unit is directed along a direct radiation path of the receiver unit.

14. The method according to claim 13, wherein in step c), a “self-test mode” operating mode of the LiDAR sensor system is carried out by carrying out a check of: (i) time signal wavelengths, or (ii) laser diodes, or (iii) groups of laser diodes on the transmitter unit, for expected functionalities.

15. The method according to claim 13, wherein different external angular ranges are measured by the LiDAR sensor system by rotating the at least one mirror, the at least one mirror including a polygon mirror.

16. The method according to claim 15, wherein, depending on the rotation of the polygon mirror, a transition is carried out from a “measuring mode” operating mode to the “self-test mode” operating mode and vice versa.

17. The method according to claim 16, wherein in the “measuring mode” operating mode, light is transmitted to the receiver unit substantially via reflection as reflected radiation from objects.

18. The method according to claim 15, wherein, in the “self-test mode” operating mode, light is directed substantially on a direct light path as transmitted radiation to the receiver unit.

19. The method according to claim 15, wherein, an acceptance range is set in accordance with the rotational position of the at least one polygon mirror in relation to the transmitter unit, in such a way that no transmitted radiation passes directly from the transmitter unit to the receiver unit.

20. The method according to claim 13, wherein the radiation emitted by the transmitter unit substantially runs in a form of at least one vertical line.

21. The method according to claim 13, wherein the receiver unit is configured to receive radiation in a form of at least one vertical line.

22. The method according to claim 13, wherein: (i) the receiver unit includes a detector, or (ii) the detector is assigned to the receiver unit, the detector being a line detector.

23. The method according to claim 13, wherein:
in the first operating mode, an alignment of the at least one mirror occurs in such a way that a direction of reflected radiation is influenced and at least one further mirror receives the reflected radiation and reflects the received reflected radiaton in the direction of the receiver unit, and
in the second operating mode, the alignment of the at least one mirror occurs in such a way that the transmitted radiation of the transmitter unit is directed along the direct radiation path of the receiver unit via the at least one further mirror.

24. The method according to claim 13, wherein the method is used in a LiDAR sensor system of a vehicle or a consumer electronic device.
